(19) United States
(12) Patent Application Publication
(10) Pub. No.: US 2020/0271078 A1
(43) Pub. Date: Aug. 27, 2020

(54) FUEL INJECTOR

(71) Applicant: Robert Bosch GmbH, Stuttgart (DE)

(72) Inventors: Jens Pohlmann, Bietigheim-Bissingen (DE); Kai Gartung, Stuttgart (DE)

(21) Appl. No.: 16/066,811

(22) PCT Filed: Dec. 2, 2016
(86) PCT No.: PCT/EP2016/079569

§ 371 Date: Jun. 28, 2018

(30) Foreign Application Priority Data
Dec. 29, 2015 (DE) 10 2015 226 769.5

(51) Int. Cl. F02M 51/06; F02M 61/18

(52) U.S. Cl. CPC F02M 51/061; F02M 61/1806; F02M 2200/8046; F02M 2200/9053; F02M 2200/9007

(57) ABSTRACT

The fuel injector according to the invention is distinguished in that a particularly high structural strength and vibration resistance of the valve seat body (5) is provided. The fuel injector (1) includes an excitable actuator for actuating a valve closing body, which forms a seal seat together with a valve seat surface (6) formed on a valve seat body (5), and injection openings (7), which are formed downstream of the valve seat surface (6), the injection openings (7) being introduced into a middle area (44) of the valve seat body (5) protruding outwardly like a cone in the injection direction. The cone-like axially protruding middle area (44) of the valve seat body (5) ends radially outside the orifice areas of all injection openings (7) in a recessed depression (47), from which, in turn, an axially protruding border area (48) of the valve seat body (5) adjoins radially outwardly, so that an overall wavy cone contour of the valve seat body (5) is formed in cross section. The fuel injector is particularly suitable for direct injection of fuel into a combustion chamber of a mixture-compressing spark-ignited internal combustion engine.

### BACKGROUND INFORMATION

The present invention is directed to a fuel injector according to the definition of the species in the main claim.

Specific embodiments of known valve seat bodies are shown in FIGS. 1, 2a, 2b, and 2c. FIGS. 2a, 2b, and 2c show schematic views of three fundamentally typical constructions of valve seat bodies having injection openings. While in the known and proven approach according to FIG. 2c, the valve seat body terminates the downstream valve end of the fuel injector toward the combustion chamber with a planar and flat end face, in the also known approaches according to FIGS. 2a and 2b, the valve seat bodies are formed having a middle area of the valve seat body which includes the injection openings and protrudes outward like a cone in the injection direction. This is either a disk cone having a conical lateral surface in the middle area (for example, DE 10 2013 219 027 A1) or a sphere cone having a bulge extending spherically convexly outwardly (for example, EP 2 333 306 A1). In both cases, the cone-like middle area of the valve seat body merges seamlessly and in continuous progress into a planar and flat end face of the valve seat body.

In such valve seat bodies, the entire cone area is a strength-critical area. It is strained by the millions of impacts of the valve needle with its valve seat body. Moreover, the system pressure of the fuel acts over the entire surface on the entire inner side of the cone-like middle area. These loads act, with the risk of bending of the cup area, with negative influence on the quality of the valve seat surface, the leak tightness requirements, and the fatigue strength of the valve seat body in this area.

### Advantages of the Invention

The fuel injector according to the present invention having the characterizing features of claim 1 has numerous further advantages in addition to simple and cost-effective manufacturing capability. According to the present invention, a cone-like axially protruding middle area of the valve seat body of the fuel injector is designed in such a way that it ends in an ideally circumferentially recessed depression radially outside the orifice areas of all injection openings, from which, in turn, an axially protruding border area of the valve seat body adjoins radially outwardly, so that an overall wavy cone contour of the valve seat body is formed in cross section.

The strength-relevant tensions are effectively reduced in relation to cone-like middle areas of valve seat bodies according to the related art. Due to the structural separation between the area of the load dissipation (“foundation” of the border area) and the area for the injection openings (“function area”), a significantly higher load capacity of the cone center results for the cone-like middle area. A fatigue strength level of the cone-like middle area of 1000 MPa is achievable in this way and thus significantly exceeds the level of known approaches. The above-mentioned fatigue strength level may be arithmetically determined for a number of load cycles ≥1E8 in consideration of a static probability of failure ≤1 ppm.

Thanks to the high load capacity, it is possible to reduce the wall thickness of the cone-like middle area in the area of the injection openings, without increasing the risk of a fatigue fracture. It is thus conceivable to implement a low wall thickness in the middle area of less than 500 μm. The reduction of the cone wall thickness in turn enables a reduction of the length of the injection openings or the length of the preliminary stages of the injection openings. This contributes to an optimization of the spray properties, in particular a reduction of the jet penetration.

Furthermore, it is to be emphasized that an uncontrolled exit of fuel is prevented immediately after the end of the injection. Bouncing of the valve needle with the valve closing body on the valve seat surface typically occurs during the closing of the fuel injector, so that undesirable opening phases still briefly follow the closing procedure. This uncontrolled emitted quantity of fuel results in a small deviation of the injected quantity of fuel from the setpoint value, so that a disadvantageous effect in the engine operation may not be precluded. The probability of bouncing may be extremely reduced using the design according to the present invention of the cone-like middle area, since the wavy cone has a high inherent rigidity.

A further advantage of the present invention is that fewer soot deposits arise on the outer side of the cone-like middle area during engine operation than in the case of known fuel injectors. A temperature distribution which prevents the rapid growth of the soot coatings is achieved in the component due to the design according to the present invention of the valve seat body.

Because of the low coating formation on the surface of the valve seat body, the design according to the present invention offers greater security against the clogging of the injection openings (“carbonization”). In consideration of the fuel quality, which varies greatly worldwide, this robust behavior is very advantageous.

Furthermore, it is advantageous that the resulting increase of the particle emissions in the exhaust gas induced by continuous engine operation is less than in the case of fuel injectors according to the related art (reduction of the PN drift).

Since the wavy cone according to the present invention has an improved cooling effect and a lesser tendency toward coating formation, fewer particle emissions are also formed after continuous operation.

Advantageous refinements of and improvements on the fuel injector specified in claim 1 are possible by way of the measures set forth in the subclaims.

It is particularly advantageous that the geometrical design of the valve seat body is adaptable on its lower end face facing toward the combustion chamber very flexibly to desired installation conditions and requirements for the engine operation.

### BRIEF DESCRIPTION OF THE DRAWINGS

Exemplary embodiments of the present invention are shown in simplified form in the drawings and explained in greater detail in the following description.

FIG. 1 shows a schematic section through a fuel injector in a known embodiment having a valve seat body including injection openings on the downstream valve end,

FIGS. 2a, 2b, 2c show schematic views of various known constructions of valve seat openings including injection openings as detail II-XIV from FIG. 1 in an enlarged view in each case,

FIG. 3 shows a first exemplary embodiment according to the present invention of a valve seat body in a detail view comparable to FIG. 2,

FIG. 4 shows a second exemplary embodiment according to the present invention of a valve seat body in a detail view comparable to FIG. 2,

FIG. 5 shows a third exemplary embodiment according to the present invention of a valve seat body in a detail view comparable to FIG. 2,

FIG. 6 shows a fourth exemplary embodiment according to the present invention of a valve seat body in a detail view comparable to FIG. 2,

FIG. 7 shows a fifth exemplary embodiment according to the present invention of a valve seat body in a detail view comparable to FIG. 2,

FIG. 8 shows a sixth exemplary embodiment according to the present invention of a valve seat body in a detail view comparable to FIG. 2,

FIG. 9 shows a seventh exemplary embodiment according to the present invention of a valve seat body in a detail view comparable to FIG. 2,

FIG. 10 shows an eighth exemplary embodiment of a valve seat body according to the present invention in a detail view comparable to FIG. 2,

FIG. 11 shows a ninth exemplary embodiment according to the present invention of a valve seat body in a detail view comparable to FIG. 2,

FIG. 12 shows a tenth exemplary embodiment according to the present invention of a valve seat body in a detail view comparable to FIG. 2, and

FIG. 13 shows an eleventh exemplary embodiment according to the present invention of a valve seat body in a detail view comparable to FIG. 2.

### DETAILED DESCRIPTION OF THE INVENTION

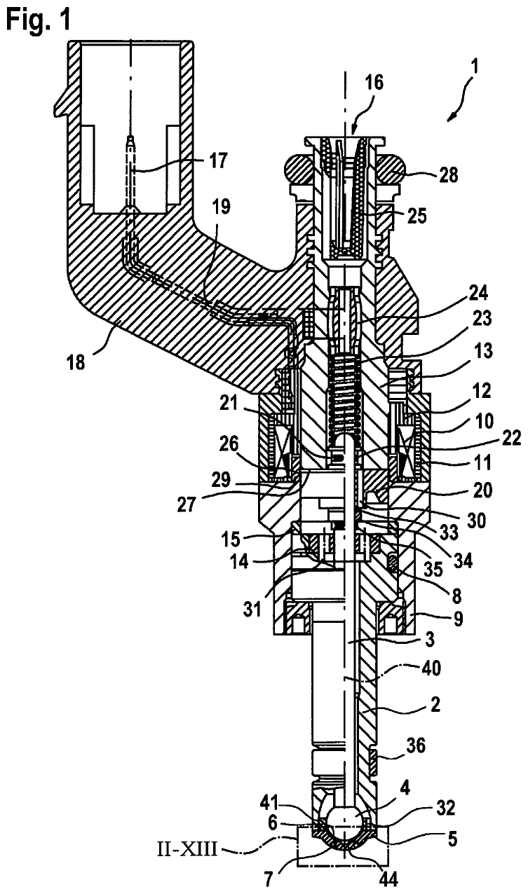

A known example of a fuel injector 1 shown in FIG. 1 is designed in the form of a fuel injector 1 for fuel injection systems of mixture-compressing, spark-ignited internal combustion engines. Fuel injector 1 is suitable in particular for the direct injection of fuel into a combustion chamber (not shown) of an internal combustion engine.

Fuel injector 1 includes a nozzle body 2, in which a valve needle 3 is situated. Valve needle 3 is operationally connected to a valve closing body 4, which cooperates with a valve seat surface 6 situated on a valve seat body 5 to form a seal seat.

Valve seat body 5 and nozzle body 2 may also be designed in one piece. Fuel injector 1 is, in the exemplary embodiment, an inwardly opening fuel injector 1, which has at least one injection opening 7, but typically at least two injection openings 7. Fuel injector 1 is ideally, however, designed as a multi-hole injector and therefore has between four and thirty injection openings 7. Nozzle body 2 is sealed by a seal 8 in relation to a valve housing 9. An electromagnetic circuit, for example, which includes a solenoid coil 10 as an actuator, which is encapsulated in a coil housing 11 and is wound on a coil carrier 12, which rests against an inner pole 13 of solenoid coil 10, is used as the drive. Inner pole 13 and valve housing 9 are separated from one another by a constriction 26 and are connected to one another by a nonferromagnetic connecting component 29. Solenoid coil 10 is excited via a line 19 by an electrical current which may be supplied via an electrical plug contact 17. Plug contact 17 is enclosed by a plastic casing 18, which may be extruded onto inner pole 13. Alternatively, piezoelectric or magnetostrictive actuators are also usable.

Valve needle 3 is guided in a valve needle guide 14, which is designed in a disk shape. A paired adjustment disk 15 is used for the stroke adjustment. An armature 20 is located on the other side of adjustment disk 15. This armature is connected in a friction-locked manner via a first flange 21 to valve needle 3, which is connected by a weld seam 22 to first flange 21. A restoring spring 23, which is brought to pre-tension by an adjusting sleeve 24 in the present configuration of fuel injector 1, is supported on first flange 21.

Fuel ducts 30, 31, and 32 extend in valve needle guide 14, in armature 20, and on a guide body 41. The fuel is supplied via a central fuel supply 16 and filtered by a filter element 25. Fuel injector 1 is sealed by a seal 28 in relation to a fuel distributor line (not shown in greater detail) and by a further seal 36 in relation to a cylinder head (not shown in greater detail).

A ring-shaped damping element 33, which is made of an elastomeric material, is situated on the downstream side of armature 20. It rests on a second flange 34, which is connected in a friction-locked manner via a weld seam 35 to valve needle 3.

In the idle state of fuel injector 1, restoring spring 23 is applied to armature 20 against its stroke direction in such a way that valve closing body 4 is held in sealing contact on valve seat surface 6. Upon excitation of solenoid coil 10, it builds up a magnetic field, which moves armature 20 against the spring force of restoring spring 23 in the stroke direction, the stroke being specified by a working gap 27 located in the idle position between inner pole 12 and armature 20. Armature 20 also entrains first flange 21, which is welded to valve needle 3, in the stroke direction. Valve closing body 4 connected to valve needle 3 lifts off of valve seat surface 6, and the fuel is injected through injection openings 7.

If the coil current is turned off, armature 20 drops off from inner pole 13 due to the pressure of restoring spring 23 after sufficient dissipation of the magnetic field, whereby first flange 21 connected to valve needle 3 moves opposite to the stroke direction. Valve needle 3 is thus moved in the same direction, whereby valve closing body 4 settles on valve seat surface 6 and fuel injector 1 is closed.

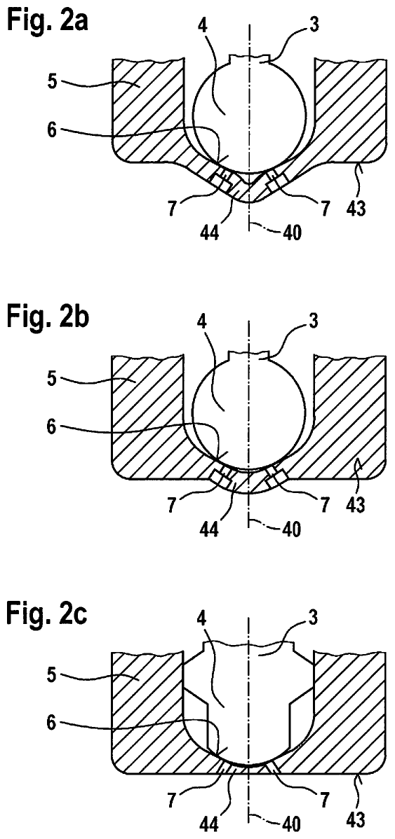

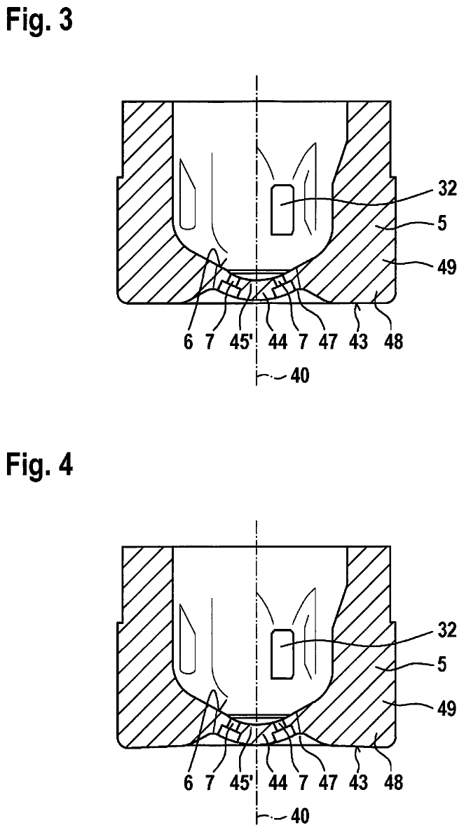

Specific embodiments of known valve seat bodies 5 are shown in FIGS. 1, 2a, 2b, and 2c. A comparable detail II-XIV of FIG. 1 is also selected in an enlarged view in each of all further FIGS. 3 through 13 to illustrate the design and contouring according to the present invention on valve seat body 5.

FIGS. 2a, 2b, and 2c show very schematic views of three fundamental typical designs of valve seat bodies 5 including injection openings 7. While in the known and proven approach according to FIG. 2c, valve seat body 5 terminates downstream valve end of fuel injector 1 toward the combustion chamber with a planar and flat end face 43, in the also known approaches according to FIGS. 2a and 2b, valve seat bodies 5, are designed having a middle area 44 of valve seat body 5, which includes injection openings 7, protrudes outwardly like a cone in the injection direction, and is formed rotationally-symmetrical to a valve longitudinal axis 40. The exemplary embodiment according to FIG. 2a is a disk cone having a conical lateral surface in middle area 44, while middle area 44 of the specific embodiment according to FIG. 2b is designed as a sphere cone curved spherically convexly outward. In both cases, cone-like middle area 44 of valve seat body 5, similarly to the embodiment according to FIG. 2c, merges seamlessly and in continuous progress into planar and flat end face 43 of valve seat body 5.

The goal of the present invention is to produce a valve seat body 5 for a fuel injector 1 including multiple injection openings 7, which has a higher structural strength in spite of a cone-like middle area 44, which is thus designed as less sensitive to bending tension than in the related art. According to the present invention, cone-like axially protruding middle area 44 of valve seat body 5 therefore ends radially outside the orifice areas of all injection openings 7 in a recessed depression 47, which is ideally formed circumferentially and from which, in turn, an axially protruding border area 48 of valve seat body 5 adjoins radially outwardly, so that in cross section an overall wavy cone contour of valve seat body 5 is formed. Cone-like axially protruding middle area 44, has a radially delimited dimension and an axial extension which protrudes only slightly if at all beyond end face 43.

A first exemplary embodiment according to the present invention of a valve seat body 5 is shown in FIG. 3 in a detail view comparable to FIG. 2. In contrast to the embodiment shown in FIG. 1, in valve seat body 5 of all following exemplary embodiments, fuel ducts 32 are also formed directly into the guide area of valve seat body 5, which contributes to a further increase of the strength of valve seat body 5, but has no influence on the contouring according to the present invention of cone-like middle area 44. Cone-like middle area 44 is ideally formed rotationally symmetrical to valve longitudinal axis 40 and ends radially outside the orifice areas of all injection openings 7 in a circumferential recessed depression 47, which is grooved similarly to an annular bead. Cone-like middle area 44 advantageously has a significantly smaller diameter than cone-like middle areas 44 in the related art (see FIGS. 2a, 2b). An in turn axially protruding border area 48 of valve seat body 5 adjoins grooved depression 47 radially outwardly, so that in cross section an overall wavy cone contour of valve seat body 5 is formed. In the present exemplary embodiment, depression 47 and the transition of the radial outer depression edge to border area 48 are formed quite sharp edged. Border area 48 has a planar and flat end face 43 here. To produce a particularly durable and rigid “foundation” of valve seat body 5, for example, the external diameter of valve seat body 5 is also enlarged somewhat in its lower axial extension area 49.

The second specific embodiment according to the present invention of a valve seat body 5 shown in FIG. 4 in a detail view comparable to FIG. 2 is very similar to the embodiment according to FIG. 3. However, depression 47 and the transition of the radial outer depression edge to border area 48 are formed rounded here. Border area 48 again has a planar and flat end face 43. To produce a particularly durable and rigid “foundation” of valve seat body 5, for example, the external diameter of valve seat body 5 is also enlarged somewhat in its lower axial extension area 49 here.

As is inferable in particular from the exemplary embodiments of FIGS. 3 and 4, the size of bending-sensitive middle area 45′, whose size is finally approximately defined by the diameter of depression 47, on valve seat body 5 is significantly reduced in relation to the known approaches.

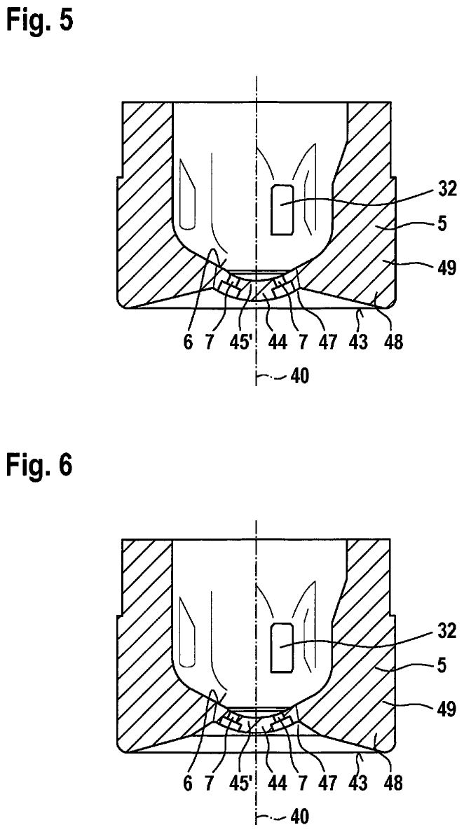

Notwithstanding the above-described exemplary embodiments, a third exemplary embodiment according to the present invention of a valve seat body 5 is shown in FIG. 5 in a detail view comparable to FIG. 2, which is distinguished in that grooved depression 47 is in turn adjoined radially outwardly by an axially protruding border area 48 of valve seat body 5, which does not merge into a planar and flat end face 43, however, but rather its end face 43 extends diagonally inclined from depression 47 up to the outer diameter of valve seat body 5. This may be referred to as an end face 43 inclined in a funnel shape.

In the fourth exemplary embodiment according to the present invention of a valve seat body 5 shown in FIG. 6 in a detail view comparable to FIG. 2, end face 43 of border area 48, which extends diagonally inclined, is divided in two, i.e., the two end face areas have different angles to valve longitudinal axis 40 and abut one another at a circumferential edge 50, so that end face 43 ultimately has a “kink”.

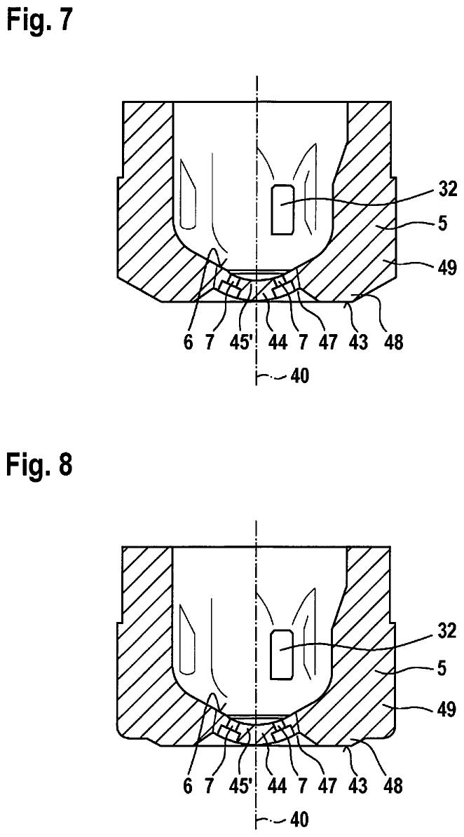

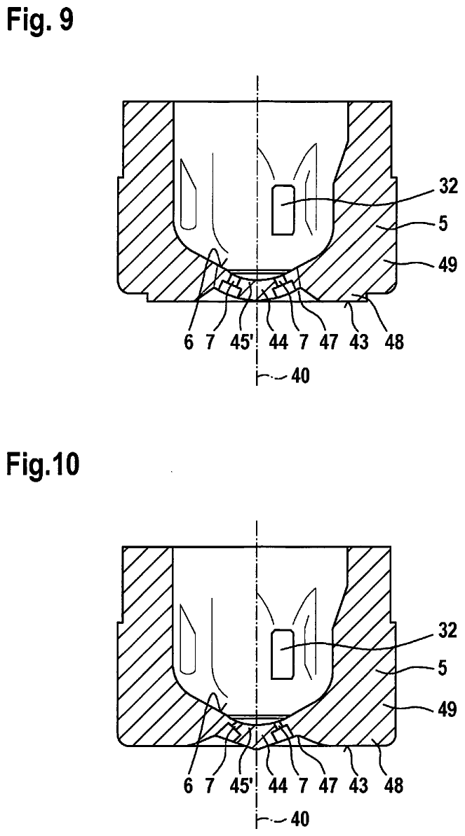

FIGS. 7, 8, and 9 show a fifth, sixth, and seventh exemplary embodiment according to the present invention of a valve seat body 5 in a detail view comparable to FIG. 2, in each of which a stepped contoured end face 43 is provided in border area 48. In all embodiments, radially outwardly from depression 47, similarly to the embodiments according to FIGS. 3 and 4, an inclined area merges into planar and flat end face 43, end face 43 being able to drop away at an incline again radially outwardly up to the external diameter of valve seat body 5 (FIG. 7) or being able to extend set back inclined in steps (FIG. 8) or sharply stepped (FIG. 9) up to the external diameter.

An eighth exemplary embodiment according to the present invention of a valve seat body 5 is shown in FIG. 10 in a detail view comparable to FIG. 2, in which cone-like middle area 44 tapers in the area of valve longitudinal axis 40, since middle area 44 of valve seat body 5 extends conically proceeding from depression 47 beyond the orifice area of injection openings 7 up to valve longitudinal axis 40. Depression 47 may either be formed rounded, as shown, or also sharp-edged. The sharp-edged tip of middle area 44 shown in FIG. 10 may alternatively also be rounded.

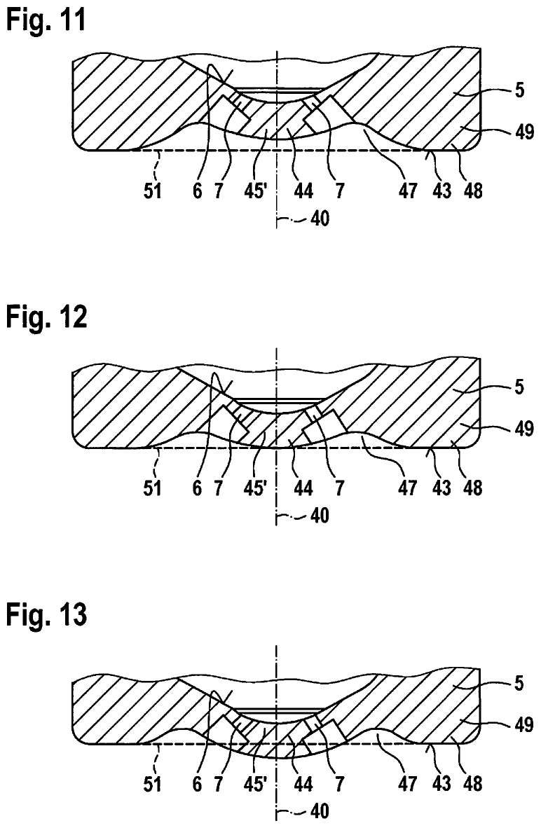

A ninth, tenth, and eleventh exemplary embodiment according to the present invention of a valve seat body 5 are shown in FIGS. 11, 12, and 13 in a detail view comparable to FIG. 2, which shows that border area 48 of valve seat body 5 extending radially outwardly from depression 47 may be formed in different ways with respect to its axial extension. Thus, in the exemplary embodiment shown in FIG. 11, middle area 44 is formed set back in relation to end face 43 of border area 48, while in the exemplary embodiment shown in FIG. 13, middle area 44 is formed protruding in relation to end face 43 of border area 48. In contrast, in the specific embodiment according to FIG. 12, middle area 44 and border area 48 lie with their downstream end faces 43 in approximately the same plane 51. It is to be noted that all geometry features shown in FIGS. 3 through 10 are combinable with each of the variants of the axial extension of middle area 44 shown in FIGS. 11 through 13.

Injection openings 7 in valve seat body 5 may be formed having a preliminary step, which is larger in diameter and extends toward the injection side, as shown in all embodiments, but may also extend cylindrically, conically having a positive or negative aperture angle, or in multiple steps, or the like. All shapes are conceivable for injection openings 7 in cross section, from round via oval to polygonal. Injection openings 7 are manufactured with the aid of erosion, laser drilling, or stamping. Injection openings 7 may be manufactured either sharp-edged at the injection hole entry or exit or may be rounded, for example, by hydro-erosive erosion.

Steel may be used as a typical material for valve seat body 5. The manufacturing of cone-like middle area 44 may therefore be carried out with the aid of machining (for example, turning, grinding, honing), by forming (for example, extruding), or also by molding (for example, metal injection molding). Aside from steel, however, other metallic materials or ceramic materials also come into consideration for valve seat body 5.

The present invention is not restricted to the exemplary embodiments shown and is usable, for example, for injection openings 7 arranged in other ways and also for arbitrary configurations of multipole fuel injectors 1 opening inwardly.

1-13. (canceled)

14. A fuel injector for direct injection of fuel into a combustion chamber, for a fuel injection system of an internal combustion engines, comprising:
an excitable actuator for actuating a valve closing body, which forms a seal seat together with a valve seat surface formed on a valve seat body, and at least one injection opening, which is formed downstream from the valve seat surface, the at least one injection opening being introduced into a middle area of the valve seat body protruding outwardly like a cone in the injection direction;
wherein the cone-like axially protruding middle area of the valve seat body ends radially outside the orifice areas of all injection openings in a recessed depression, from which an axially protruding border area of the valve seat body adjoins radially outwardly.

15. The fuel injector of claim 14, wherein an overall wavy cone contour of the valve seat body is formed in cross section.

16. The fuel injector of claim 14, wherein the cone-like middle area is formed rotationally-symmetrical to a valve longitudinal axis and the depression accordingly extends circumferentially.

17. The fuel injector of claim 16, wherein the circumferential recessed depression is grooved as an annular bead.

18. The fuel injector of claim 14, wherein the depression and/or the transition of the radial outer depression edge to the border area is formed sharp-edged or rounded.

19. The fuel injector of claim 14, wherein the border area has a planar and flat end face.

20. The fuel injector of claim 14, wherein the border area is formed having a diagonally inclined end face, which extends from the depression up to the outer diameter of the valve seat body, so that an end face inclined in a funnel shape results.

21. The fuel injector of claim 20, wherein at least two diagonally inclined partial faces of the end face having different angles to the valve longitudinal axis are provided and have an edge between them.

22. The fuel injector of claim 14, wherein the border area has a stepped contoured end face.

23. The fuel injector of claim 14, wherein the cone-like middle area is either formed to be spherically convexly bulging or tapers in the area of the valve longitudinal axis, since the middle area of the valve seat body extends conically proceeding from the depression beyond the orifice area of the injection openings up to the valve longitudinal axis.

24. The fuel injector of claim 14, wherein the middle area radially enclosed by the depression is located either set back or protruding with respect to its axial extension in relation to the radially outwardly extending border area of the valve seat body, or both areas lie with their end faces in approximately the same plane.

25. The fuel injector of claim 14, wherein the valve seat body is a metallic or ceramic component.

26. The fuel injector of claim 14, wherein between two and thirty injection openings are provided in the valve seat body.
